(19) United States
(12) Patent Application Publication
(10) Pub. No.: US 2017/0220323 A1
(43) Pub. Date: Aug. 3, 2017

(54) METHOD AND SYSTEM FOR DETERMINING ARCHITECTURAL DESIGNS FOR SOFTWARE APPLICATION

(71) Applicant: Wipro Limited, Bangalore (IN)

(72) Inventor: Melwyn Anthony DSOUZA, Bangalore (IN)

(73) Assignee: Wipro Limited

(21) Appl. No.: 15/068,822

(22) Filed: Mar. 14, 2016

(30) Foreign Application Priority Data
Jan. 29, 2016 (IN) 201641003316

(51) Int. Cl. G06F 9/44; G06F 17/30

(52) U.S. Cl. CPC G06F 8/20; G06F 8/73; G06F 17/30477

(57) ABSTRACT

The present disclosure relates to a method and system for determining architectural designs for software application. The architectural designs are determined by design retrieval system. The design retrieval system receives user inputs associated with the software application, wherein the user inputs comprise one or more attributes. The design retrieval system further generates a query string for searching a design database based on one or more patterns identified from the keywords. Based on the query string, the design retrieval system determines the architectural designs for the software application by searching the design database.

### FIELD OF THE DISCLOSURE

The present subject matter is related in general to software architectural design, more particularly but not exclusively to a method and system for determining architectural designs for software application.

### BACKGROUND

With prolonged transformation in the technology, software industry has expanded significantly with consistent increase in complexity of the software systems. The quality and longevity of any software system is known by its architecture. Over the past few decades, software architecture has acquired increasing attention as an important sub-field of software system. Software architecture forms the foundation for any of the complicated software systems and products. Having the software system rightly designed and architected would translate software into high quality software which is scalable and easily maintainable for future enhancement. However, with the growing complexities in the software front, it is sometimes critical for the software architect to produce the right design and architecture. Also, cost of developing an overall software application plays an important role, since the defects which manifests in the later stages of the software systems like coding, testing and production are generally more expensive to resolve than in the early stage of design and architecture. Hence, architectural design forms one of the most important steps in any of the software applications.

In the current scenario, the software architectures which are designed and created are generally stored in the image format. This makes it difficult to search for a particular architectural design, since it is not possible to search within an image file for textual words and patterns. In the existing technology, searching generally relies only on the name of the image file which contains the architectural designs. In addition, the searching takes place by the search inputs which are not well structured and do not result in retrieving the required architectural designs.

Thus in the existing scenario, determining a particular architectural design associated with any software application becomes difficult. Also, the existing technology limits the reuse of the architectural designs and causes additional problems. For example, if the architect does not find the required architectural design, extra efforts and time in recreating and testing architectural design are wasted which is already existing and also can lead to productivity loss. The existing design and newly created design may differ in approach which may lead to inconsistency and causes non-standardization. Consequently, there is a need for a system which predicts architectural designs for the software applications.

### SUMMARY

Disclosed herewith is a method and system for determining architectural designs for a software application. The architectural designs are determined by a design retrieval system. The design retrieval system acquires user inputs which include one or more attributes associated with the software application. Based on the one or more attributes, the design retrieval system determines the architectural design by generating a query string to search the design database containing the architectural designs for different software applications.

In an embodiment, the present disclosure relates to a method for determining software architectural designs for software application the method comprises receiving user inputs associated with the software application. The user inputs comprise one or more attributes associated with the architectural designs. The method comprises generating a query string for searching a design database based on one or more patterns identified from the one or more attributes and determining the architectural designs for the software application by searching the design database based on the query string.

In an embodiment, the present disclosure relates to a design retrieval system for determining architectural designs for a software application. The design retrieval system comprises a processor and a memory communicatively coupled to the processor, wherein the memory stores processor executable instructions, which, on execution, causes the design retrieval system to receive user inputs associated with the software application. The user inputs comprise one or more attributes associated with the architectural designs. The design retrieval system generates a query string for searching a design database based on one or more patterns identified from the one or more attributes and determines the architectural designs for the software application by searching the design database based on the query string.

In an embodiment, the present disclosure relates to a non-transitory computer readable medium including instructions stored thereon that when processed by at least one processor cause a design retrieval system to receive user inputs associated with the software application, wherein the user inputs comprise one or more attributes associated with the architectural design, generate a query string for searching a design database based on one or more patterns identified from the one or more attributes and determine the architectural designs for the software application by searching the design database based on the query string.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 shows an exemplary environment for determining architectural designs for a software application in accordance with some embodiments of the present disclosure;

FIG. 2a shows a detailed block diagram illustrating a design retrieval system in accordance with some embodiments of the present disclosure;

FIG. 2b shows an exemplary environment illustrating data flow between different modules of the design retrieval system in accordance with some embodiment of the present disclosure;

FIG. 3 illustrates a flowchart showing a method for determining architectural designs for a software application in accordance with some embodiments of present disclosure; and

FIG. 4 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

The present disclosure relates to a method for determining or predicting architectural designs for a software application. The method provides architectural designs for the software application based on the user inputs. The present disclosure provides a design retrieval system which determines or predicts architectural designs for the software application by generating a query string for searching the architectural designs in a design database. The query string is generated from one or more patterns identified by the design retrieval system. The one or more patterns are identified from keywords by applying techniques including, but not limited to, machine learning, artificial intelligence, and pattern analysis and recognition techniques. The architectural designs are obtained from the design database which stores the architectural designs along with one or more attributes associated with the architectural designs. In such a way, architectural designs are determined for a software application, which are scalable to meet increased workloads and can be maintained for future use.

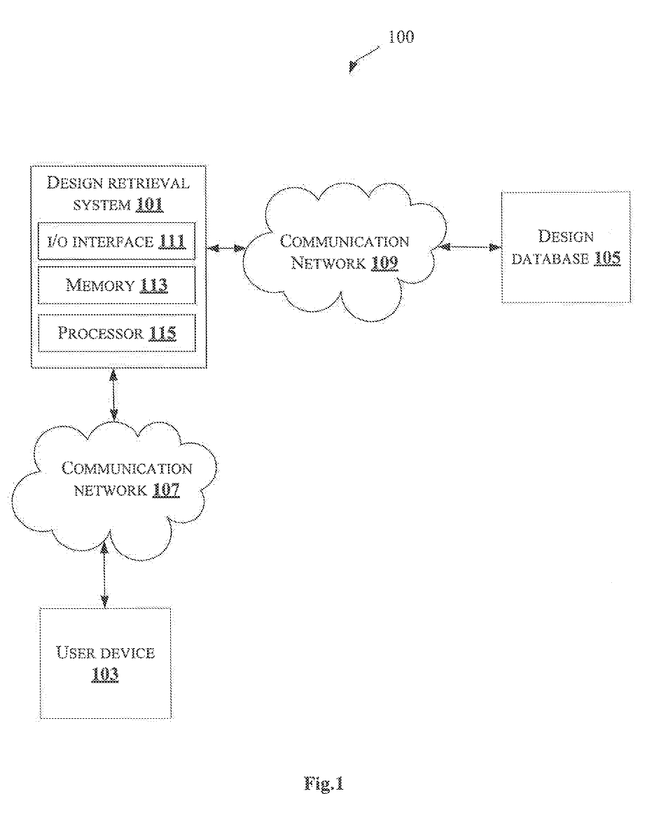

FIG. 1 shows an exemplary environment for determining architectural designs for a software application in accordance with some embodiments of the present disclosure.

As shown in FIG. 1, the environment 100 comprises a design retrieval system 101, a user device 103₁, user device 103₂, . . . user device 103ₙ (collectively called as user devices 103) and a design database 105. The design retrieval system 101 is connected to the user device 103 through a wired or wireless communication network 107. In an embodiment, the design retrieval system 101 may be connected to the user devices 103 directly without the communication network 107. The design retrieval system 101 is connected to the design database 105 through a communication network 109. In an embodiment, the design retrieval system 101 may be connected to the design database directly without the communication network 109. In an embodiment, the user devices 103 may include, but is not limited to computer systems, mobile phones, laptops, tablets or any other devices through which user inputs can be provided etc. The design retrieval system 101 determines architectural designs for the software application by generating a query string from based on one or more patterns identified based on keywords. The user inputs are received by the design retrieval system 101, which includes one or more attributes associated with the architectural design. The user inputs received are at least one of user entered attributes, business requirement document and technical specification document. In an embodiment, the users directly enter one or more attributes associated with the architectural designs. In another embodiment, the business requirement and technical specification document are provided by the users through the user devices 103. In such case, the design retrieval system 101 extracts one or more attributes from the business requirement and technical specification documents. The one or more attributes entered by the users and/or extracted by the design retrieval system 101 comprises design attributes, domain specific attributes and system specific attributes. The design attributes includes, but is not limited to, different class names related to the architectural design, relationship names between the classes, different Actor names, External entities, Object States, State Transitions, Package names, Public class methods, Interface names, Design Pattern employed, or the like. The domain specific attributes includes the attributes which are specific to a particular domain for which the software application is being developed, for example, banking, retail etc. The system specific attributes may include, but is not limited to, an Operating System (OS) platform, mobile platform, and type of database. The example of the OS platform may be Windows, UNIX, Mac OS, Linux, or Mainframe. The examples of mobile platform may be android, iOS, Symbian, Windows, Tizen, BlackBerry, or Sailfish. Similarly, the examples of database may be Oracle, SQL Server, MySQL, Postgre SQL, DB2, or Sybase. Further, the design retrieval system 101 extracts keywords from the one or more attributes. The keywords are extracted by applying pattern analysis, recognition techniques, and natural language processing techniques. The design retrieval system 101 identifies one or more patterns for the keywords by applying at least one of artificial intelligence, machine learning, and pattern analysis and recognition techniques. The design retrieval system 101 generates a query string for searching the design database 105 based on the one more patterns identified from the keywords, in order to determine the architectural designs associated with the user inputs provided by the users. The architectural designs determined for the user inputs are stored in the design database 105 along with the one or more attributes of the architectural designs. In an embodiment, the one or more attributes are validated by the design retrieval system 101 by checking the minimum availability of the one or more attributes required for determining the architectural designs. In an embodiment, the users are authenticated for using the design database 105 of an organisation.

The design retrieval system 101 comprises an I/O Interface 111, a memory 113 and a processor 115. The I/O interface 111 is configured to receive the user inputs associated with the software application from the user. The user inputs comprise one or more attributes of the architectural designs. The I/O interface 111 either receives the one or more attributes entered by the users directly or receives the business requirement and technical specification document provided by the users. The I/O interface 111 also receives the searched architectural designs and provides it to the users.

The received information from the I/O interface 111 is stored in the memory 113. The memory 113 is communicatively coupled to the processor 115 of the design retrieval system 101. The memory 113 also stores processor instructions which cause the processor 111 to execute the instruction in order to determine architectural designs associated with the software application.

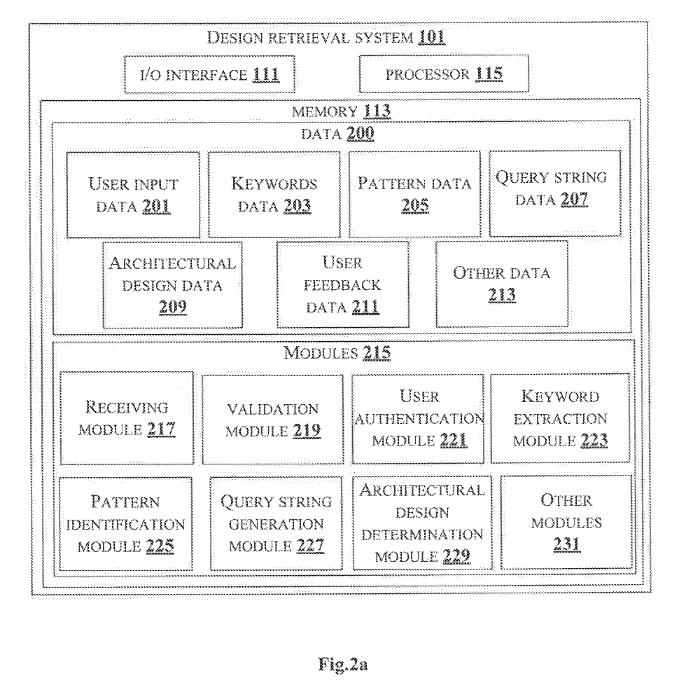

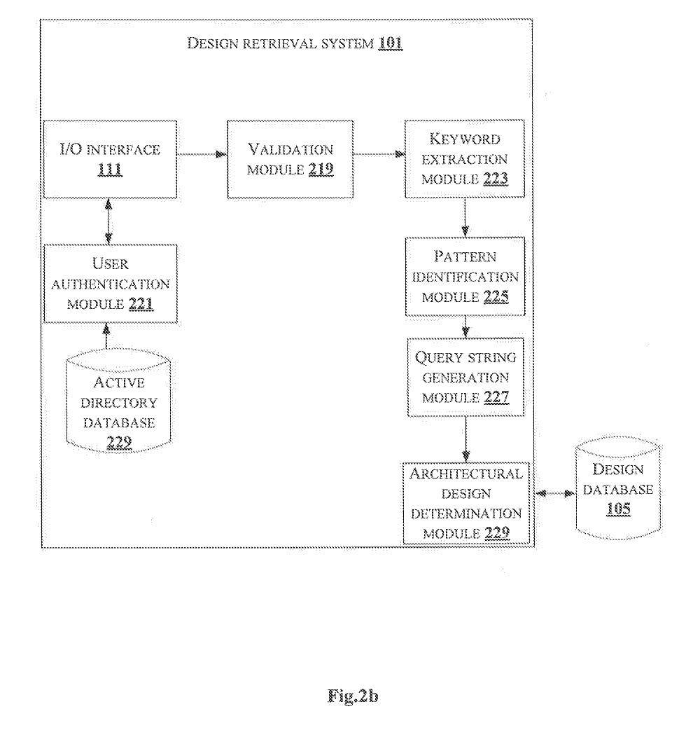

FIG. 2a shows a detailed block diagram illustrating a design retrieval system in accordance with some embodiments of the present disclosure.

In the illustrated FIG. 2a, the one or more data 200 and the one or more modules 215 stored in the memory 113 are described herein in detail. In an embodiment, the data 200 includes user input data 201, keywords data 203, pattern data 205, query string data 207, architectural design data 209, user feedback data 211 and other data 213 for determining architectural designs for a software application.

The user input data 201 comprises one or more attributes associated with the architectural designs. The user inputs are provided by the users through the user device 103. The one or more attributes are either entered by the users directly or the one or more attributes are extracted from the business requirement and technical specification documents provided by the users. The one or more attributes comprises design attributes, domain specific attributes and system specific attributes. In an embodiment, the design attributes includes for example different class names used in the software application, relationship between the classes, actors, external entities, object states, interface name etc. The domain specific attributes comprises attributes particular to a domain for which the software application is developed. The different domain specific attributes comprises attributes specific to banking, retail etc. The system specific attributes may include, but is not limited to, an Operating System (OS) platform, mobile platform, and database. In an embodiment, the attributes are extracted from the business requirement and technical specification documents depending upon the part of speech the particular words in the sentence belong to. For example, English nouns are potential classes, actors, objects or data members of a class. In addition, English verbs are potential methods of a class or relationship between classes or Interfaces. For example, “is a part of”, “contains” or similar phrases identify an aggregation relationship between classes. Similarly, “is entirely made/composed of” or similar phrases identify composition relationship between classes. The word “uses”, “utilizes” or similar phrases identify potential dependency relationship between classes. For example, a business requirement document comprises the sentence, “a customer credits his bank account”. The customer and bank account belonging to noun category are classes here and the relationship between the classes is credit, which could also be a public method of bank account class depending on context.

The keywords data 203 comprises information about the one or more keywords extracted from the one or more attributes entered by the users or extracted from the business requirement and technical specification documents. The keywords are extracted from the one or more attributes by applying pattern analysis and recognition techniques and natural language processing (NPL) techniques. For example, the user provides an attribute such as “search employee details”. The keyword extracted from this attribute is a verb “search” which is identified by applying pattern analysis and recognition techniques and natural language processing techniques. Further, the keyword ‘employee’ and details are also extracted.

The pattern data 205 comprises information about the one or more patterns identified from the keywords extracted from the one or more attributes associated with the architectural design. The one or more patterns are the alternate semantic words similar to the keywords extracted from the one or more attributes. For example, if the keyword extracted is “search”, the one or more patterns identified comprises words semantically similar words to “search” like seek, lookup, detect, discover, get, obtain etc. The one or more patterns are identified by the design retrieval system 101 by applying at least one of artificial intelligence, machine learning, and pattern recognition techniques. The one or more patterns help in generating a query string using which the design database 105 is searched for determining the architectural designs for the software application.

The query string data 207 comprises information about the query string generated for determining the architectural designs from the design database 105. The query string is generated based on the one or more patterns. The query string is generated based on the one or more patterns identified from the keywords. For example, a query string is shown below: SELECT distinct ClassTbl.ClassDiag, COUNT (DesignTbl.DesignID) AS NumberOfDesigns FROM DesignTbl INNER JOIN ClassTbl ON DesignTbl.DesignID=ClassTbl. ClassID WHERE ClassDiagName LIKE ‘% BankAccount %’ OR ClassDiagName LIKE ‘% Account %’ GROUP BY ClassDiagName HAVING COUNT (DesigTbl.DesigID)>0.

The architectural design data 209 comprises information about the architectural designs for the software applications. The architectural design data 209 comprises architecture designs mapped with the one or more attributes associated with the architectural design. The architectural designs data 209 comprises architectural designs suitable for the software application use cases and data models for the software application. For example, when designing a Point Of Sale (POS) system for a retail store, the design retrieval system 101 determines architectural design along with use cases for the customer, store, stock keeping unit (SKU), cashier and admin personnel.

The user feedback data 211 comprises information about the effectiveness of the determined architectural designs presented to users. The user feedback data 211 comprises one or more suggestions of the users to determine more relevant and efficient architectural designs for the software applications. The user feedback data 211 is used for further improving the deterministic ability of the design retrieval system 101.

The other data 213 may store data, including temporary data and temporary files, generated by modules for performing the various functions of the design retrieval system 101.

In an embodiment, the one or more data 200 in the memory 113 are processed by the one or more modules 215 of the design retrieval system 101. The one or more modules 215 may be stored within the memory 113 as shown in FIG. 2a. In an example, the one or more modules 215, communicatively coupled to the processor 115, may also be present outside the memory 113 and implemented as hardware. As used herein, the term module refers to an application specific integrated circuit (ASIC), an electronic circuit, a processor 115 (shared, dedicated, or group) and memory that execute one or more software or firmware programs, a combinational logic circuit, and/or other suitable components that provide the described functionality.

In one implementation, the one or more modules 215 may include, for example, a receiving module 217, a validation module 219, a user authentication module 221, a keyword extraction module 223, a pattern identification module 225, a query string generation module 227, and an architectural design determination module 229. FIG. 2b shows an exemplary environment illustrating data flow between different modules of the design retrieval system 101 in accordance with some embodiment of the present disclosure.

The memory 113 may also comprise other modules 231 to perform various miscellaneous functionalities of the design retrieval system 101. It will be appreciated that such aforementioned modules may be represented as a single module or a combination of different modules.

The receiving module 217 receives one or more user inputs from the user device 103 provided by the users. The user inputs comprise one or more attributes associated with the architectural design. The receiving module 217 may receive one or more attributes directly entered by the users. The receiving module 217 may also receive business requirement document and/or technical specification documents provided by the users. In an embodiment, the one or more attributes are extracted from the business requirement and technical specification documents. The one or more attributes associated with the architectural design comprise design attributes, domain specific attributes and system specific attributes. The Table 1 below shows different types of attributes for the architectural design with examples.

TABLE 1

| Attributes associated with | |
|---|---|
| architectural design | Example |
| Actors | New Customer, Account Holder, |
| | Premium Account Holder |
| Classes | BankAccount, Customer, |
| | CustomerDetails |
| Sub classes/derived classes | SavingAccount, CurrentAccount, |
| | LoanAccount, DepositAccount |
| Relationships between classes | Debits, Credits |
| External entities | CreditAgency, PaymentGateway |
| States | Active, Suspended, Dormat, Closed |
| Package names | Customer |
| Public class members | Credit, Debit, CheckBalance |
| Interface names | ATMNode, com.bank |
| Design patterns | Abstract Factory, Observer, Bridge, |
| | Composite |

The validation module 219 validates the one or more attributes associated with the architectural designs received by the receiving module 219. The validation module 219 validates the one or more attributes by identifying the missing attributes in the one or more attributes received from the users. Further, the validation module 219 checks for the minimum availability of the attributes using which the architectural designs can be determined. Further, if the validation module identifies missing attributes, the validation module 219 prompts the users to provide with the missing attributes in order to determine the architectural designs associated with the software application.

The user authentication module 221 authenticates the one or more users attempting to connect with the design database 105 in order to retrieve the architectural designs for a software application. The users are authenticated to ensure that the users have the rights to access the design database 105 of the organisation. In a non-limiting embodiment, the user authentication module 221 authenticates one or more users by prompting the users to enter the username and the password to access the design database 105. Once the users provide the username and password, the user authentication module 221 verifies the entered details by comparing with the valid users entries stored in the active user directory database 229 of the organisation. The active user directory database 229 as shown in FIG. 2b comprises all the valid users in an organization.

The keyword extraction module 223 extracts one or more keywords from the one or more attributes provided by the users. In an exemplary embodiment, the keyword extraction module 223 identifies the keywords by applying pattern analysis and recognition techniques and natural processing language technique to the one or more attributes. A person skilled in the art would understand that any other technique for extracting keywords can be used with the present disclosure.

The pattern identification module 225 identifies one or more patterns for the keywords extracted from the one or more attributes provided by the users and/or extracted attributes. The one or more patterns are identified by applying at least one of artificial intelligence, machine learning and pattern analysis and recognition techniques. The pattern identification module 225 identifies one or more patterns by generating alternate semantic terms for the keywords obtained from the keyword extraction module 223. For example, if the keyword obtained is “search” for a particular interface, the pattern identification module 225 generates additional one or more patterns similar to the keyword “search”, like ‘seek’, ‘lookup’, ‘explore’, ‘detect’, ‘discover’, ‘get’, ‘obtain’ or terms semantically similar to the keyword etc.

The query string generation module 227 generates a query based on the one or more patterns identified from the keywords. The query string is used for searching the design database 105 for the architectural designs of the software application.

The architectural design determination module 229 determines architectural designs for the software application based on the query string generated by the query string generation module 227. The architectural designs are determined from the design database 105, which stores the architectural design along with the attributes of the architectural design. The architectural designs are determined by the architectural design determination module 229 by searching the design database 105 with the query string generated by the query string generation module 227. The architectural design determination module 229 provides the users with the architectural designs corresponding to the matched attributes in the design database 105. In an embodiment, determining may also include predicting the architectural designs for the software application.

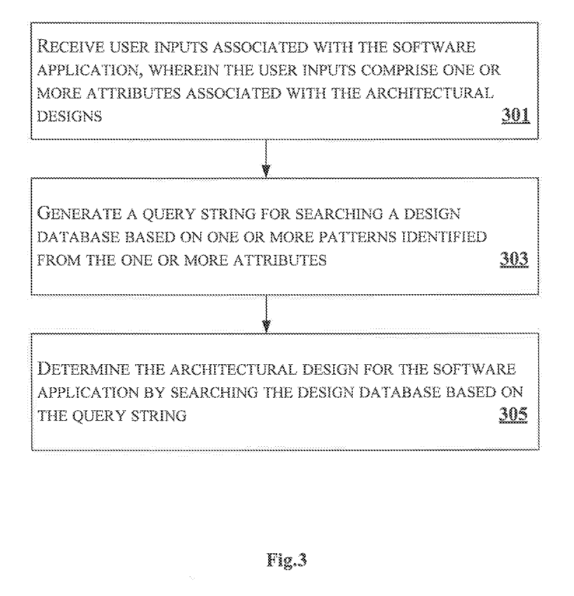

FIG. 3 illustrates a flowchart showing a method for determining architectural designs for a software application in accordance with some embodiments of present disclosure.

As illustrated in FIG. 3, the method 300 comprises one or more blocks for determining the architectural designs for the software application. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 301, the design retrieval system 101 receives user inputs associated with the software application. The user inputs comprise one or more attributes associated with the architectural design. The user inputs received are at least one of user entered attributes, business requirement document and technical specification document. Further, keywords are extracted from the one or more attributes by applying pattern analysis and recognition techniques and natural processing language techniques.

At block 303, the design retrieval system 101 generates a query string for searching a design database 105 based on one or more patterns identified from the one or more attributes. The one or more patterns are identified from the extracted keywords. The one or more patterns are identified by applying at least one of artificial intelligence, machine learning and pattern recognition techniques.

At block 305, the design retrieval system 101 determines the architectural designs for the software application by searching the design database 105 based on the query string. The architectural designs are stored along with the one or more attributes associated with the architectural design in the design database 105.

### Computing System

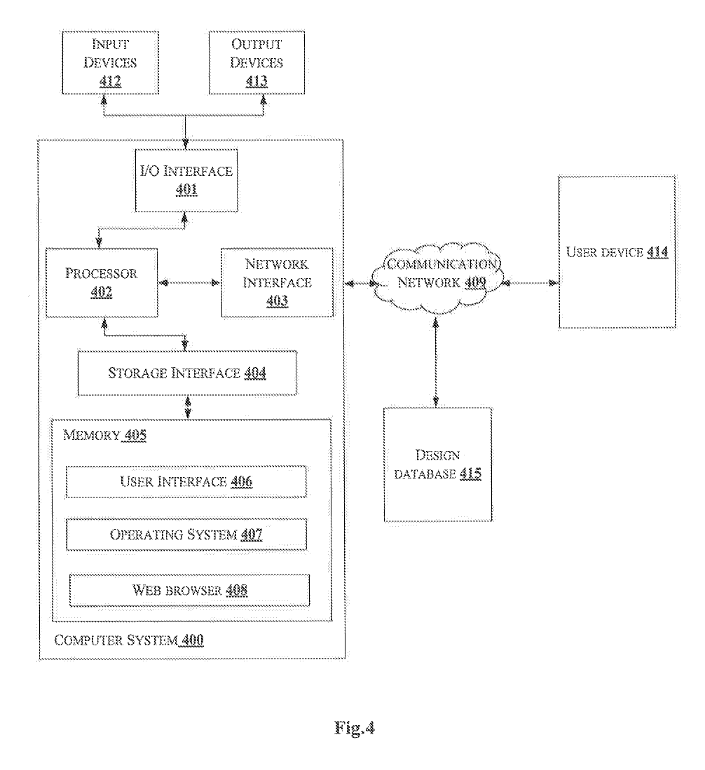

FIG. 4 illustrates a block diagram of an exemplary computer system 400 for implementing embodiments consistent with the present disclosure. In an embodiment, the computer system 400 is used to implement the design retrieval system. The computer system 400 may comprise a central processing unit (“CPU” or “processor”) 402. The processor 402 may comprise at least one data processor for determining architectural designs for a software application. The processor 402 may include specialized processing units such as integrated system (bus) controllers, memory management control units, floating point units, graphics processing units, digital signal processing units, etc.

The processor 402 may be disposed in communication with one or more input/output (I/O) devices (not shown) via I/O interface 401. The I/O interface 401 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 401, the computer system 400 may communicate with one or more I/O devices. For example, the input device may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the computer system 400 consists of a design retrieval system. The processor 402 may be disposed in communication with the communication network 409 via a network interface 403. The network interface 403 may communicate with the communication network 409. The network interface 403 may employ connection protocols including, without limitation, direct connect, Ethernet (e.g., twisted pair 10/100/1000 BaseT), transmission control protocol/internet protocol (TCP/IP), token ring, IEEE 802.11a/b/g/n/x, etc. The communication network 409 may include, without limitation, a direct interconnection, local area network (LAN), wide area network (WAN), wireless network (e.g., using Wireless Application Protocol), the Internet, etc. Using the network interface 403 and the communication network 409, the computer system 400 may communicate with the user devices 414 and design database 415. The network interface 403 may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network 409 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor 402 may be disposed in communication with a memory 405 (e.g., RAM, ROM, etc. not shown in FIG. 3) via a storage interface 404. The storage interface 404 may connect to memory 405 including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, user interface 406, an operating system 407, web browser 408 etc. In some embodiments, computer system 400 may store user/application data, such as the data, variables, records, etc. as described in this disclosure. Such databases may be implemented as fault-tolerant, relational, scalable, secure databases such as Oracle or Sybase.

The operating system 407 may facilitate resource management and operation of the computer system 400. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like.

In some embodiments, the computer system 400 may implement a web browser 408 stored program component. The web browser 408 may be a hypertext viewing application, such as Microsoft Internet Explorer, Google Chrome, Mozilla Firefox, Apple Safari, etc. Secure web browsing may be provided using Secure Hypertext Transport Protocol (HTTPS), Secure Sockets Layer (SSL), Transport Layer Security (TLS), etc. Web browsers 408 may utilize facilities such as AJAX, DHTML, Adobe Flash, JavaScript, Java, Application Programming Interfaces (APIs), etc. In some embodiments, the computer system 400 may implement a mail server stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the computer system 400 may implement a mail client stored program component. The mail client may be a mail viewing application, such as Apple Mail, Microsoft Entourage, Microsoft Outlook, Mozilla Thunderbird, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, CD ROMs, DVDs, flash drives, disks, and any other known physical storage media.

An embodiment of the present disclosure determines architectural designs for software application which are scalable and easily maintainable for future use.

An embodiment of the present disclosure provides a predictive system using text and data analytics for searching architectural designs based on certain architectural attributes.

The present disclosure provides a better way to store, search, retrieve and catalogue architectural designs associated with software application.

An embodiment of the present disclosure helps in improving the productivity, reducing the inconsistency with an organisation and also reduces re-work and maintenance efforts.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media comprise all computer-readable media except for a transitory. The code implementing the described operations may further be implemented in hardware logic (e.g., an integrated circuit chip, Programmable Gate Array (PGA), Application Specific Integrated Circuit (ASIC), etc.).

Still further, the code implementing the described operations may be implemented in “transmission signals”, where transmission signals may propagate through space or through a transmission media, such as an optical fibre, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” comprises non-transitory computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the invention, and that the article of manufacture may comprise suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 3 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERALS

| Reference | |
|---|---|
| Number | Description |
| 100 | Environment |
| 101 | Design retrieval system |
| 103 | User devices |
| 105 | Design database |
| 107 | Communication network |
| 109 | Communication network |
| 111 | I/O Interface |
| 113 | Memory |
| 115 | Processor |
| 200 | Data |
| 201 | User input data |
| 203 | Keywords data |
| 205 | Pattern data |
| 207 | Query string data |
| 209 | Architectural design data |
| 211 | User feedback data |
| 213 | Other data |
| 215 | Modules |
| 217 | Receiving module |
| 219 | Validation Module |
| 221 | User authentication module |
| 223 | Keyword extraction module |
| 225 | Pattern identification module |
| 227 | Query string generation module |
| 229 | Architectural design determination module |
| 231 | Other modules |

What is claimed is:

1. A method for determining architectural designs for a software application, the method comprising:
receiving, by a design retrieval system, user inputs associated with the software application, wherein the user inputs comprise one or more attributes associated with the architectural designs;
generating, by the design retrieval system, a query string for searching a design database based on one or more patterns identified from the one or more attributes; and
determining, by the design retrieval system, the architectural designs for the software application by searching the design database based on the query string.

2. The method as claimed in claim 1, wherein the one or more attributes comprises at least one of design attributes, domain specific attributes and system specific attributes.

3. The method as claimed in claim 1, wherein the user inputs are at least one of user entered attributes, business requirement document and technical specification document.

4. The method as claimed in claim 1, further comprising validating the one or more attributes associated with the architectural designs by checking for missing attributes in the one or more attributes.

5. The method as claimed in claim 1, further comprising extracting keywords from the one or more attributes.

6. The method as claimed in claim 5, wherein the one or more patterns comprises using alternate semantic keywords similar to the keywords obtained from the one or more attributes.

7. The method as claimed in claim 1, wherein the one or more patterns are identified by at least one of artificial intelligence, machine learning and pattern analysis and recognition techniques.

8. The method as claimed in claim 1, wherein the architectural designs are stored in the design database along with the one or more attributes associated with the architectural designs.

9. A design retrieval system for determining architectural designs for a software application, comprising:
a processor; and
a memory communicatively coupled to the processor, wherein the memory stores processor instructions, which, on execution, causes the processor to:
receive user inputs associated with the software application, wherein the user inputs comprise one or more attributes associated with the architectural designs;
generate a query string for searching a design database based on one or more patterns identified from the one or more attributes; and
determine the architectural designs for the software application by searching the design database based on the query string.

10. The design retrieval system as claimed in claim 9, wherein the one or more attributes comprises at least one of design attributes, domain specific attributes and system specific attributes.

11. The design retrieval system as claimed in claim 9, wherein the processor receives the user inputs from at least one of user entered attributes, business requirement document and technical specification document.

12. The design retrieval system as claimed in claim 9 further comprising validating the one or more attributes associated with the architectural designs by checking for missing attributes in the one or more attributes.

13. The design retrieval system as claimed in claim 9, wherein the processor is further configured to extract keywords from the one or more attributes.

14. The design retrieval system as claimed in claim 13, wherein the one or more patterns comprises using alternate semantic keywords similar to the keywords obtained from the one or more attributes.

15. The design retrieval system as claimed in claim 9, wherein the one or more patterns are identified by at least one of artificial intelligence, machine learning and pattern analysis and recognition techniques.

16. The design retrieval system as claimed in claim 9, wherein the architectural designs are stored in the design database along with the one or more attributes associated with the architectural designs.

17. A non-transitory computer readable medium including instruction stored thereon that when processed by at least one processor cause a design retrieval system to perform operation comprising:
receiving user inputs associated with the software application, wherein the user inputs comprise one or more attributes associated with the architectural designs;
generating a query string for searching a design database based on one or more patterns identified from the one or more attributes; and
determining the architectural designs for the software application by searching the design database based on the query string.

18. The medium as claimed in claim 17, wherein the one or more attributes comprises at least one of design attributes, domain specific attributes and system specific attributes.

19. The medium as claimed in claim 17, wherein the instruction causes the processor to receive the user inputs from at least one of user entered attributes, business requirement document and technical specification document.

20. The medium as claimed in claim 17 further comprising validating the one or more attributes associated with the architectural designs by checking for missing attributes in the one or more attributes.
